(19) United States
(12) Patent Application Publication
(10) Pub. No.: US 2005/0033787 A1
(43) Pub. Date: Feb. 10, 2005

(54) Multi channel grating design

(76) Inventors: Dmitrii Yu Stepanov, Croydon Park (AU); Kazimir Kolossovski, Macquarie (AU); Alexander Buryak, Killara (AU)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/647,897

(22) Filed: Aug. 25, 2003

Related U.S. Application Data
(63) Continuation of application No. PCT/AU02/00160, filed on Feb. 15, 2002.

(30) Foreign Application Priority Data
Feb. 26, 2001 (AU) AU PR 3359

(51) Int. Cl. G06F 17/14

(52) U.S. Cl. 708/400

(57) ABSTRACT

A method of calculating a sampling function for fabricating a N-channel grating, the method comprising the steps of forming a summation of N periodic seeding functions each describing a refractive index variation, wherein each periodic function includes a phase shift value Φ₁(1=1, . . . N) with respect to the other functions, and wherein at least one phase shift value is non-zero. The sampling function may be expressed as: Σ? exp[i (K₀Z+θ+(21−N−1)ΔKZ/2+Φ₁]=KQ exp[i (K₀z+θ+ψ)], where Q=Q(z) is the amplitude and ψ=ψ(z) is the phase of the sampling function, and the summation is performed over 1=1, . . . N. The method may further include the step of determining a set of the phase shift values for which a maximum value of the sampling function amplitude is minimised.

### FIELD OF THE INVENTION

The present invention relates broadly to a multi-channel grating design method and to multi-channel grating structures fabricated utilising the multi-channel grating design method.

### BACKGROUND OF THE INVENTION

Multi-channel grating structures are typically written into photosensitive waveguides. The grating structure comprises a refractive index profile induced in the photosensitive waveguide, which in turn determines the optical characteristics such as the reflection, transmission, and group delay characteristics of the resulting grating structure.

The refractive index profile for a multi-channel grating structure is induced by applying a sampling function to a given single-channel grating profile, the single-channel grating profile typically being a periodic profile achieved by exposing the photosensitive waveguide to an appropriate light beam emerging from e.g. a suitable phasemask.

In a vast majority of previously reported work on multi-channel gratings, a so-called Sinc-sampled design has been used. For the Sinc-sampling approach, an N-channel grating design can be obtained by a direct in-phase summation of N identical seeding gratings [with κ(z)—amplitude grating amplitude, θ(z)—grating phase] equally spaced in the frequency space:

$${\sum }_{l = 1}^{N} {κⅇ}^{ⅈ [ {K}_{0} z + θ + ( 2 l - N - 1 ) Δκ z / 2 ]} = κ {Q}_{Sinc} {ⅇ}^{ⅈ ( {K}_{{0}^{2}} + θ )} , where \\ {Q}_{Sinc} = {\sum }_{l = 1}^{N} cos [ 2 l - N - 1 ) Δ k z / 2 ] = N {\sum }_{n = - ∞}^{+ ∞} sinc [ N ( Δ k z - 2 π n ) / 2 ] , sinc ( x ) ≡ sin ( x ) / x , \qquad ( 1 )$$

and Δk is the channel spacing.

This design will be referred to as “in-phase” grating design herein after by the applicant.

An example of this design is shown in FIGS. 9 (c) and (d) with corresponding spectral characteristics as shown in FIGS. 9 (a) and (b). The maximum value of the refractive index change required to implement this multi-channel grating design is given by a simple expression:

$$Δ {n}_{N}^{( max )} = N Δ {n}_{s} , \qquad ( 2 )$$

where Δnₛ is the maximum refractive index change required for the single seeding grating. Since any photosensitive fiber used to fabricate Bragg gratings has material limits of the maximum achievable photoinduced refractive index change Δn_{N} this represents a limitation on the maximum number of channels that can be recorded in a given fiber. Thus it is highly desirable to reduce a required Δn_{N} as much as possible.

At least preferred embodiments of the present invention seek to provide an alternative multi-channel grating design in which the maximum refractive index change required as a function of the number of channels is reduced without deterioration of the grating spectral characteristics when compared with the prior art grating designs discussed above.

### SUMMARY OF THE INVENTION

In accordance with a first aspect of the present invention there is provided a method of calculating a sampling function for fabricating a N-channel grating, the method comprising the steps of forming a summation of N periodic seeding functions each describing a refractive index variation, wherein each periodic function includes a phase shift value with respect to the other functions, and wherein at least one of the phase shift values is non-zero.

Accordingly, the present invention can provide a “de-phased” grating design rather than the “in-phase ” prior art grating design.

Preferably, the summation of the N periodic functions comprises a Fourier analysis. The result of the Fourier analysis may be expressed as:

$${\sum }_{l = 1}^{N} {κⅇ}^{ⅈ [ {K}_{0} z + θ + ( 2 l - N - 1 ) Δ κ z / 2 + {ϕ}_{l} )} = κ Q {ⅇ}^{l ( {K}_{0} z + θ + ψ )} ,$$

where Q is the amplitude and ψ is the phase of the sampling function.

The method may further comprise the step of determining a set of the phase shift values for which a maximum of the sampling function amplitude Q is minimised.

Alternatively, the method further may comprise the step of determining a set of the phase shift values for which a maximum difference between a minimum and a maximum of the sampling function amplitude Q minimised.

Alternatively, the method may further comprise the step of determining a set of the phase shift values for which a mean-square-deviation in the sampling function amplitude Q is minimised.

The step of determining the set of phase shift values may comprise direct scanning through all combinations or conducting a variational analysis, or using other forms of extremum search numerical techniques, or a simulated annealing Monte Carlo approach.

The grating may be multi-dimensional, wherein the periodic seeding functions are multi-dimensional.

In accordance with a second aspect of the present invention, there is provided a method for fabricating a multi-channel grating comprising the step of calculating a sampling function in accordance with a method as defined in the first aspect.

The multi-channel grating may e.g. be fabricated utilising photo-induced refractive index changes in a photosensitive waveguide material, etching techniques, or epitaxial techniques, or a developing technique such as a photo polymerisation process.

In accordance with a third aspect of the present invention, there is provided a multi-channel grating structure fabricated utilising a method of fabrication as defined in the second aspect.

### BRIEF DESCRIPTION OF THE DRAWINGS

Preferred forms of the present invention will now be described with reference to the accompanying drawings.

FIG. 1 shows a four-channel grating design using the sampling function with minimised maximum amplitude embodying the present invention.

FIG. 2 shows the maximum value (maximum minimisation) of the sampling function amplitude for different number of channels. (a) Comparison with the worst case (in-phase sampling function design). (b) Comparison with the asymptotic theoretical value \sqrt{N}.

FIG. 3 shows a 16-channel grating design using maximum minimisation approach embodying the present invention.

FIG. 4 shows the maximum value (difference minimisation) of the sampling function amplitude for different number of channels.

FIG. 5 shows a 16-channel grating design using the difference minimization approach embodying the present invention.

FIG. 6 shows a 17-channel grating design using the variational minimization approach embodying the present invention.

FIG. 7 shows the maximum value (variational approach) of the sampling function amplitude for a different number of channels.

FIG. 8 shows an experimental set up for writing a multi-channel grating structure of a multi-channel grating design embodying the present invention.

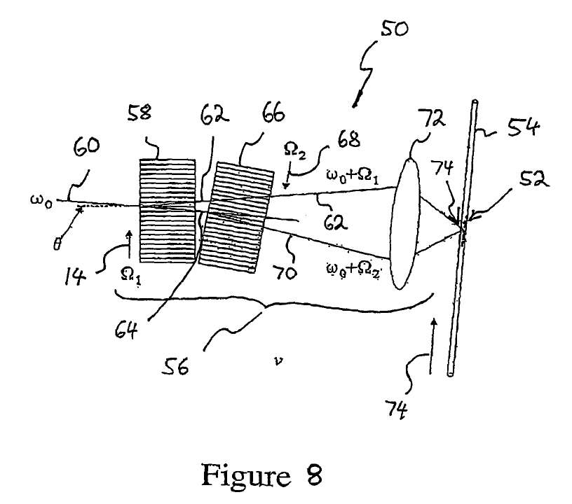

FIG. 9 shows a prior art four-channel grating design using an in-phase-sampling function.

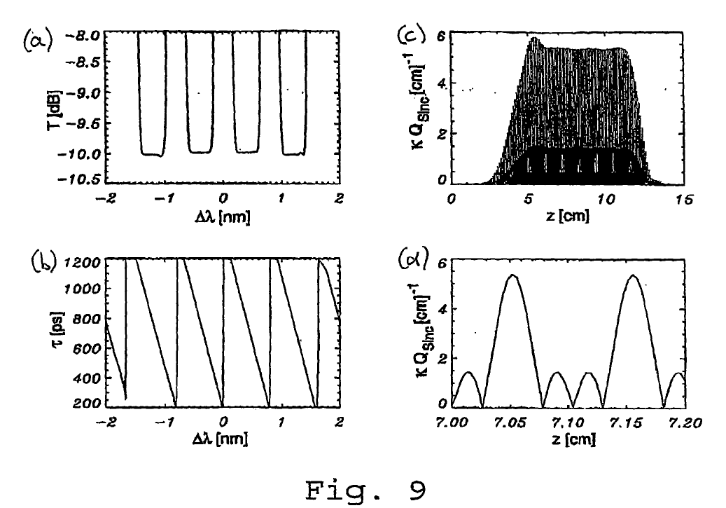

### DETAILED DESCRIPTION OF THE EMBODIMENTS

The preferred embodiment described provides a multi-channel grating design in which the maximum refractive index change is less than directly proportional to the number of channels N, and which avoids the presence of un-wanted side bands in the spectral characteristics of the resulting grating, thereby improving on prior art multi-channel grating designs.

In the preferred embodiment, a sampling function which periodically modulates the amplitude of a given single-channel grating (seeding grating) is utilised similar to prior art multi-channel grating designs. However, in addition to the periodic modulation of the amplitude of the seeding grating, a periodic modulation of the phase of the seeding grating is also introduced. Accordingly, the resulting design function in the preferred embodiment may be expressed as:

$${\sum }_{l = 1}^{N} {κⅇ}^{ⅈ [ {K}_{0} z + θ + ( 2 l - N - 1 ) Δ κ z / 2 + {ϕ}_{l} )} = κ Q {ⅇ}^{l ( {K}_{0} z + θ + ψ )} \qquad ( 3 )$$

where the phase of the sampling function ψ=ψ(z) and the sampling amplitude Q=Q(z) are given by:

$${Q}^{2} ( z ) = 4 {\sum }_{l , p = 1}^{N / 2} cos ( {α}_{l} - {α}_{p} ) cos ( {n}_{l} Δ k z / 2 + {β}_{l} ) cos ( {n}_{p} Δ k z / 2 + {β}_{p} ) , and$$

$$ψ ( z ) = {tan}^{- 1} [ \frac{{\sum }_{l = 1}^{N / 2} sin {α}_{l} cos ( {n}_{l} Δ k z / 2 + {β}_{l} )}{{\sum }_{l = 1}^{N / 2} cos {α}_{l} cos ( {n}_{l} Δ k z / 2 + {β}_{l 〉} )} ] , N is even or$$

$${Q}^{2} ( z ) = 4 {\sum }_{l = 1}^{( N - 1 ) / 2} {cos}_{l} cos ( {n}_{l} Δ k z / 2 + {β}_{l} ) + 4 {\sum }_{l , p = 1}^{( N - 1 ) / 2} cos ( {α}_{l} - {α}_{p} ) cos ( {n}_{l} Δ k z / 2 + {β}_{l} ) cos ( {n}_{p} Δ k z / 2 + {β}_{p} ) + 1 , \\ and$$

$$ψ ( z ) = {tan}^{- 1} [ \frac{{\sum }_{l = 1}^{( N - 1 ) / 2} sin {α}_{l} cos ( {n}_{l} Δ k z / 2 + {β}_{l} )}{{\sum }_{l = 1}^{( N - 1 ) / 2} cos {α}_{l} cos ( {n}_{l} Δ k z / 2 + {β}_{l 〉} )} ] , N is odd ,$$

where n₁≡21−N−1 and nₚ ≡2p−N−1.

In the above expressions for Q(z) and ψ(z) we use notations α≡(φ₁+φ_{N+1-1})/2β₁≡(φ₁−φ_{N+1-1})/2and set φ_{(N+1)/2}=0 for odd numbers of channels. Now for any given N there will be a set of {α₁}, {β₁} (or equivalently a set of {φ₁} ) which optimizes the sampling function amplitude Q(z) along the grating structure according to a selected optimization approach. By direct calculations it is straightforward to show that

$${\int }_{0}^{z π / Δ k} {Q}^{2} ⅆ z = 2 π N / Δ k , \qquad ( 4 )$$

for any choice of α₁ and β₁. This expression, in turn, leads to an asymptotic formula for the minimum possible Δn_{N} corresponding to an “ideal” situation when O(z)=\sqrt{N} and only the grating phase is nontrivially modulated (by addition of an appropriately chosen phase of the sampling function ψ(z)):
Δn_{N}=\sqrt{N}Δnₛ. (5)

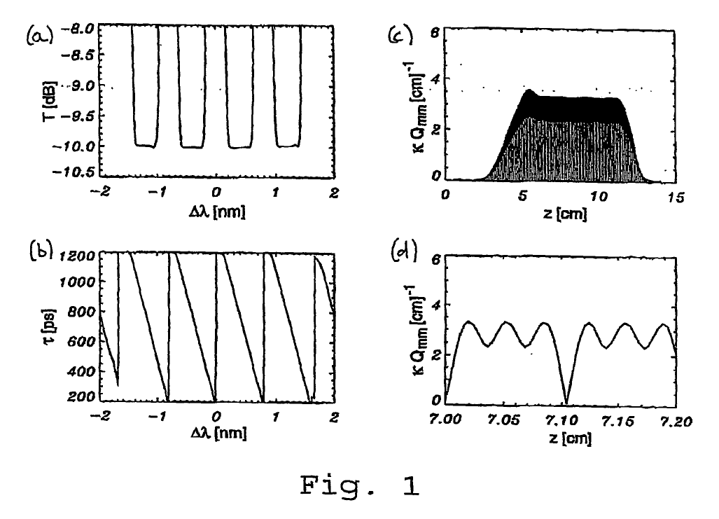

We note, that, in practice, the limit Q(z)=\sqrt{N} can be reached only approximately. For example, for the maximum minimization approach, one should solve a minimax problem and find Qₘₘ(Z;α^{(opt)}₁, β^{(opt)}₁) for which max_{z}{Qₘₘ(Z;α^{(opt)}₁, β^{(opt)}₁)}=min_{(α}₁β₁)max_{z}{Q(z;α₁, β₁)}. To find the optimal set φ₁ for a relatively small number of channels one may use direct numerical scanning through all possible combinations of the dephasing angles. An example of the optimized “out-of-phase” design for a four-channel grating is shown in FIG. 1(a)-(d). For this design α₁=0.5759π, β₂=0, β₁=β₂=0. This design reduces the maximum Δn_{N} of the in-phase design by almost 40%.

For N>>1 location of the minimizing set (α^{(opt)}₁, β^{(opt)}₁) is a nontrivial exercise. Even rough direct scanning through all possible sets of angles (followed by efficient numerical minimum search routines) quickly becomes numerically inefficient To solve the optimization problem for large N we use, in an example embodiment the so-called simulated annealing method—a Monte Carlo approach for minimization of multi-variable functions. This statistical method samples the search space in such a way that there is a high probability of finding an optimal or a near-optimal solution in a reasonable time. The term “simulated annealing” is derived from the analogy to physical process of heating and then slowly cooling a substance to obtain a crystalline structure.

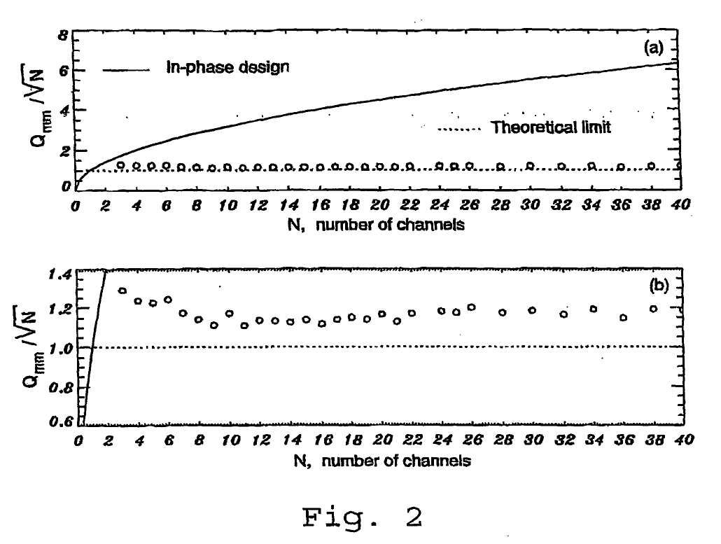

To start, the system state is initialized. A new configuration is constructed by imposing a random displacement. If the energy of the new state is lower than that of the previous one, the change is accepted and the system is updated. If the energy is greater, the new configuration is accepted with some probability. This procedure allows the system to move consistently towards lower energy states, yet still jump out of local minimal due to the probabilistic acceptance of some upward moves. Results of the application of simulated annealing to the maximum minimization approach are summarised in FIG. 2

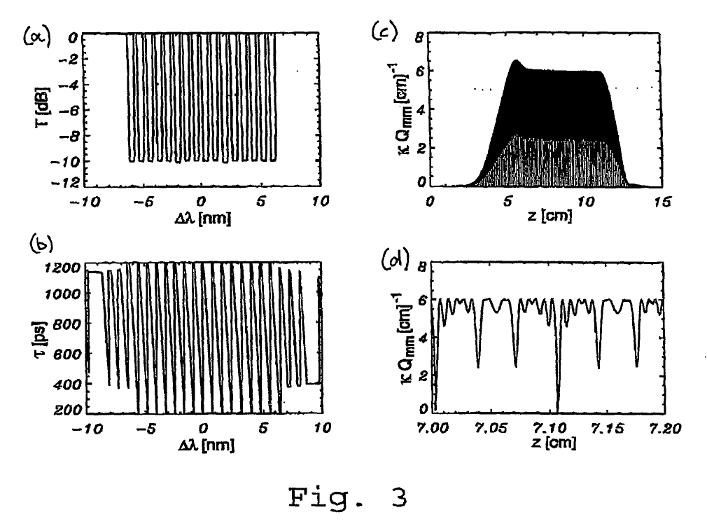

FIG. 2 shows that Eq. (5) gives a reasonable estimate for Δn_{N} (20% accuracy or better) for N>6. The growth factor to \sqrt{N} represents a significant improvement in comparison to linear ˜N dependence (almost a factor of 4 reduction for 16-channel gratings, 8 for 64-channel ones and so on). An example of the optimal 16-channel grating design is shown in FIG. 3(a)-(d).

FIGS. 1 and 3 demonstrate implementation of Qₘₘ(z) reduction strategy without trying to avoid touching the zero level at some z. Zeros in the fibre Bragg grating (FBG) amplitude may lead to the increased phase errors (appearance of phase jumps) and should be * avoided. Thus, arguably, the best minimization strategy could be not in reducing the maximum value of Q(z) along z, but in minimizing the maximum difference between the maximum and minimum of the sampling function amplitude. Mathematically this may be formulated as finding Q_{dm}(z;α^{(opt)}₁, β^{(opt)}₁) for which max₂{Q_{dm}(z;α^{(opt)}₁, β^{(opt)}₁)}−min_{z}{Q_{dm}(z;α^{(opt)}₁, β^{(opt)}₁)}=min_{α}₁, β₁)[max_{z}{Q(z;α₁, β₁)}−min_{z}{Q(z;α₁, β₁)}].

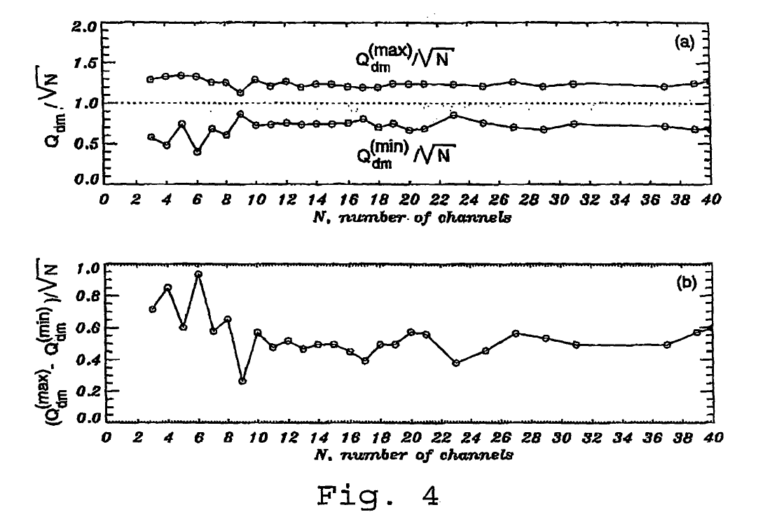

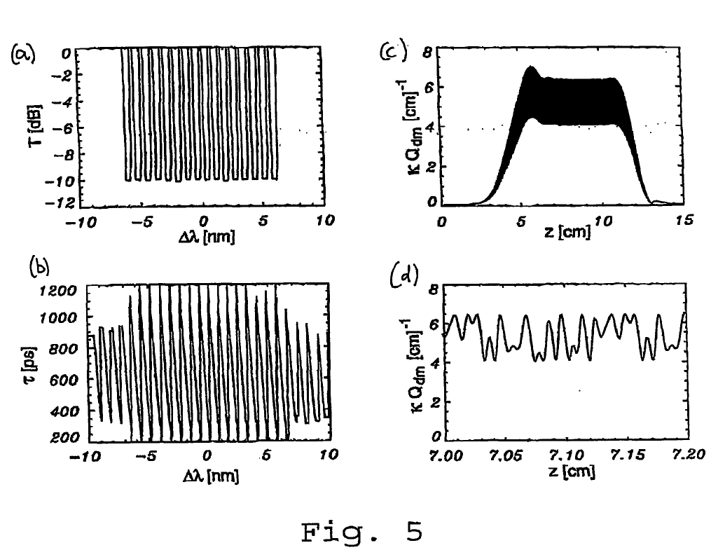

This approach may be implemented by using the same simulated annealing algorithm, and the corresponding results are given in FIG. 4. An example of this version of optimal (difference minimisation) “out-of-phase” design for a 16-channel grating is shown in FIG. 5(a)-(d). The total minimization of Δn_{N}, is slightly worse than in FIG. 3, but the zeros in the grating amplitude are avoided.

It is noted that for both the maximum minimisation and the difference minimisation approaches, points with the best optimisation quality may be used to get reasonable (but not exactly the best) optimisation for some higher channel numbers. For example, the point N=9 with the particularly good optimisation quality provides us with an effortless optimisation for N=81 number of channels.

Another embodiment will now be described, in which optimization by the functional minimisation (variational approach) is utilised. The key property of this embodiment is that it relies on estimate of some integral functional rather than time-consuming numerical scanning in z. Quantitatively, proximity of Q(z) to the theoretical limit \sqrt{N} can be characterised by mean-square-deviation,

ΔQ=√(Q(z)−\overline{Q})² , (6)

where ƒ(z) ≡\overline{ƒ}=Δk/2π ƒ(z)dz Ideal optimisation of Q(z) corresponds to the achievement of the average \overline{Q}=\sqrt{N} and the zero mean-square-deviation from this average value. Using expression (4) and assuming \overline{Q}≈\sqrt{N}, one can show that

ΔQ ≈\sqrt{(2−E)EN}, (7)

where

$$E = \frac{1}{4 {N}^{2}} {\sum }_{l = 1}^{N} {{\sum }_{p = 1}^{N}}_{\vert l - p \vert \geq 1} {\sum }_{m = 1}^{N - \vert l - p \vert} cos ( {α}_{m} - {α}_{m + \vert l - p \vert} ) cos ( {α}_{l} + {β}_{l} - {α}_{p} - {β}_{p} + {β}_{m} - {β}_{m + \vert l - p \vert} ) .$$

For finding minima of ΔQ the most efficient strategy is again the use of the simulated annealing method.

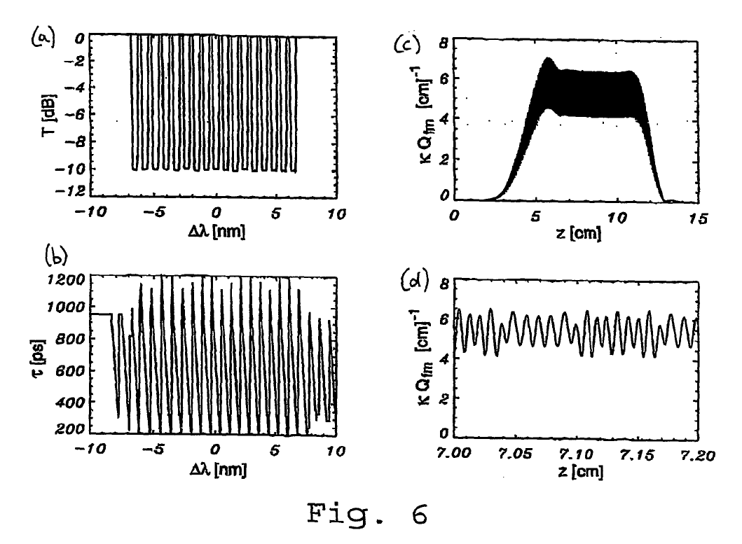

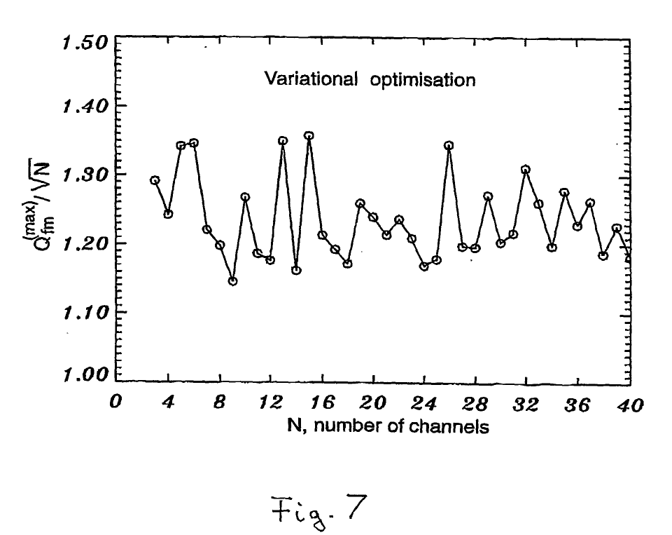

The major advantage of the optimisation based on the functional minimisation compared with direct scanning is the speed: integration over z is carried out analytically which saves lots of computer time However. the quality of variational optimisation itself is usually not as good. That said, for odd number of channels variational optimisation leads to a sampling fiction without zeros in amplitude (similar to difference minimisation approach). An example for a 17-channel grating design (variational approach) is shown in FIG. 6(a)-(d). For even number of channels variational optimisation leads to a sampling function with zeros in amplitude (similar to maximum minimisation approach) FIG. 7 shows the maximum value (variational approach) of the sampling function amplitude for a different number of channels.

The advantages of the dephasing optimisation approaches of the embodiments described include that they give a very significant reduction for the maximum required Δn_{N}. Moreover, they are conceptually simple and relatively easy to obtain Furthermore, the limitation of the number of dephased periodic functions to N for a N-channel grating design avoids the presence of un-desired side bands, which can deteriorate the quality of spectral characteristics of the grating. The applicants have recognised that the limiting of the number of dephased periodic functions to N while allowing variations in the amplitude of the resulting sampling function can enable design of Noel gratings of improved quality when compared with prior art designs.

The implementation of the multi-channel grating design of the preferred embodiment in a grating structure requires grating writing apparatus with high spatial resolution to be utilised. Therefore, in a grating writing apparatus relying on photoinduced refractive index changes, the apparatus preferably comprises a beam focusing means to reduce the size of the beam in the core of the photosensitive waveguide.

FIG. 7 shows an example experimental set up 50 for writing a multi-channel grating 52 into au optical fibre 54. The experimental set up 50 comprises an interferometer 56 which includes a first acousto-optic modulation 58 being operated under an acousto-optic wave at a first frequency Ω₁, as indicated by arrow 14. An incoming light beam 60 is incident on the first acousto-optic modulator 58 at a first order Bragg angle. The operating conditions of the acousto-optic modulator 58 are chosen such that the modulator 5 is under driven, whereby approximately 50% of the incoming beam 60 is diffracted into a first order beam 62, and 50% passing through the acousto-optic modulator 58 as an un-diffracted beam 64. The un-diffracted beam 64 is incident on a second acousto-optic modulator 66 of the interferometer 56 at a first order Bragg angle, whereas the beam 62 is not. Accordingly, the beam 62 passes through the second acousto-optic modulator 66 without any significant loss.

The second acousto-optic modulator 66 is operated under an acousto-optic wave at a frequency Ω₂, which propagates in a direction opposing the direction of the acousto-optic wave in the first modulator 58 as indicated by arrow 68. After the second acousto-optic modulator 66 the first order diffracted beam 70 and the beam 62 are frequency shifted in the same direction (e.g. higher frequency), but by different amounts i.e. Ω₁ v Ω₂.

The beams 62, 70 are then brought to interfere utilising an optical lens 72, and the resulting interference pattern (at numeral 74) induces refractive index changes in the photosensitive optical fibre 54, whereby a refractive index profile, i.e. grating structure 52, is induced in the optical fibre 54.

In FIG. 7, the optical fibre 54 is translated along the interferometer at a speed ν, as indicated by arrow 74.

It will be appreciated by a person skilled in the art that the experimental set up SO shown in FIG. 5 can be utilised to write a multi-channel grating structure of a multi-channel grating design embodying the present invention through suitable control of the first and second acousto-optic modulators 58, 66, in conjunction with a suitable control of the speed ν at which the optical fibre 54 is translated along the interferometer 56 at any particular time The high spatial resolution required to implement the multi-channel design of the preferred embodiment is achieved in the set up shown in FIG. 6 by utilising the optical lens 72, with the practical limit of the beam size in the focal plane preferably being of the order of the waveguide core size

It will be appreciated by a person skilled in the art that numerous variations and/or modifications may be made to the present invention as shown in the specific embodiments without departing from the spirit of scope of the invention as broadly described. The present embodiments are, therefore, to be considered in all respects to be illustrative and not restrictive.

For example, multi-channel gratings can be fabricated on the basis of the multi-channel grating design of the present invention using various known grating writing techniques, including one or more of the group of photo-induced refractive index variation in photo sensitive waveguide materials, etching techniques including etching techniques utilising a phasemask, and epitaxial techniques. Furthermore, while the preferred embodiments have been described in the context of 1-dimensional Bragg gratings, the present invention does extend to multi-dimensional multi-channel gratings. Such gratings have applications e.g. as photonic bandgap structures.

1. A method of calculating a sampling function for fabricating a N-channel grating, the method comprising the steps of:
forming a summation of N periodic seeding functions each describing a refractive index variation, wherein each periodic function includes a phase shift value with respect to the other functions, and wherein at least one phase shift value is non-zero.

2. A method as claimed in claim 1, wherein the summation of the N periodic functions comprises a Fourier analysis.

3. A method as claimed in claim 2, wherein the result of the Fourier analysis is expressed as:
$${\sum }_{l = 1}^{N} {κⅇ}^{ⅈ [ {K}_{0} z + θ + ( 2 l - N - 1 ) Δ κ z / 2 + {ϕ}_{l} )} = κ Q {ⅇ}^{l ( {K}_{0} z + θ + ψ )} .$$

4. A method as claimed in claim 1, wherein the method further comprises the step of determining a set of the phase shift values for which a maximum value of the sampling function amplitude is minimised.

5. A method as claimed claim 1, wherein the method further comprises the step of determining a set of the phase shift values for which a maximum difference between a maximum and minimum value of the sampling function amplitude is minimised.

6. A method as claimed in claim 1, wherein the method further comprises the step of determining a set of the phase shift values for which a mean-square- deviation in the sampling function is minimised.

7. A method as claimed in claim 4, wherein the step of determining the set of phase shift values comprises direct scanning through all combinations, or conducting a variational analysis, or using other forms of extremum search numerical techniques, or a simulated annealing Monte Carlo approach.

8. A method as claimed in claim 1, wherein the grating is multi-dimensional, and wherein the periodic seeding functions are multi-dimensional.

9. A method for fabricating a multi-channel grating comprising the step of calculating a sampling function in accordance with a method as claimed in claim 1.

10. A method as claimed in claim 9, wherein the multi-channel grating is fabricated utilising photo-induced refractive index changes in a photosensitive waveguide material.

11. A method as claimed in claim 9, wherein the multi-channel grating is fabricated utilising etching techniques.

12. A method as claimed in claim 9, wherein the multi-channel grating is fabricated utilising epitaxial techniques.

13. A method as claimed in claim 9, wherein the multi-channel grating is fabricated utilising a developing technique.

14. A method as claimed in claim 13, wherein the developing technique comprises a photo polymerisation process.

15. A multi-channel grating structure fabricated utilising a method of fabrication as claimed in claim 9.
